(19) United States
(12) Patent Application Publication
(10) Pub. No.: US 2004/0101018 A1
(43) Pub. Date: May 27, 2004

(54) Suspension system for laser discharge unit

(76) Inventors: Syb Leijenaar, Hengelo (NL); Peter Rutgers, Hengelo (NL); Wieland Hill, Dortmund (DE)

Correspondence Address: STALLMAN & POLLOCK LLP, Attn: Brian J. Keating, Suite 290, 121 Spear Street, San Francisco, CA, 94105, US

(21) Appl. No.: 10/645,947

(22) Filed: Aug. 22, 2003

Related U.S. Application Data
(60) Provisional application No. 60/407,096, filed on Aug. 28, 2002.

(51) Int. Cl. H01S 3/08

(52) U.S. Cl. 372/107

(57) ABSTRACT

A suspension system for suspending a laser discharge unit (LDU) is provided herein. The suspension system includes steel W-springs instead of rubber blocks. The new design increases long time position stability and position accuracy after remounting of the LDU. Further isolation of vibrations caused by the fan of the LDU to the optics frame is increased, too. With the new steel W-spring suspension the maximum amplitudes of the vibrations are a factor 2.5 till 6 lower than with the rubber block suspension.

### RELATED APPLICATION

The present application claims benefit from U.S. Provisional Patent Application Serial No. 60/407,096 filed Aug. 28, 2002, which is incorporated herein by reference.

### FIELD OF THE INVENTION

The present invention relates generally to lithographic devices for the fabrication of integrated circuits on semiconductor wafers. More specifically, the present invention relates to a new type of laser discharge unit suspension for lithographic excimer lasers.

### BACKGROUND

Lithographic devices are commonly used to transfer an image from a recticle onto a semiconductor wafer. A typical lithographic device includes a laser system and a lens assembly that cooperate to transfer an image of an integrated circuit from the reticle onto the wafer. Gas discharge lasers commonly include a fan which circulates the lasing gas inside of the laser chamber. The laser chamber is filled with a predetermined gas mixture and a pulsed gas discharge is generated in the discharge region by a high voltage pulse applied between a cathode assembly and an anode assembly. The cathode and anode assembly define the discharge region. The output light propagates from the discharge region through the optical output window.

The fan which circulates the gas mixture in the laser chamber causes undesirable vibrations which have a strong influence on the bandwidth, the energy stability and on the wavelength stability of the laser.

In commercially used ArF, KrF or F₂ lasers a rubber block suspension is used but the sophisticated specifications of high repetition excimer and molecular fluorine lasers cannot be reached in this way.

For this reason it was necessary to design a new suspension for lithography lasers. The goal of this new design is an increase of the long time position stability of the laser discharge unit (LDU), an increase in position accuracy after remounting of the LDU and finally an increase in the isolation of vibrations caused by the fan of the laser chamber to the optics frame.

The long time position stability of the laser tube can be increased by a new suspension using steel W-springs instead of the rubber blocks. This new suspension increases the repeatability of the positioning of the LDU, and can provide for increased isolation of vibrations to the optics frame.

### SUMMARY OF THE INVENTION

A newly designed steel W-spring suspension provides higher position repeatability when the LDU is removed from the suspension and remounted to the suspension. Measured in Y-direction (perpendicular to the laser beam) at the output of the laser beam, the accuracy is in the range of 12 μm compared with 30 μm with previous rubber block suspensions. The position stability of the steel W-spring suspension is not influenced by time as the rubber suspension is.

One of the goals of improved position accuracy was the possibility of easy exchangeability of LDUs. The positional accuracy in Y-direction which can be reached by the steel W-spring suspension is 12 μm.

The positional accuracy of the steel W-spring suspension in Z-direction (vertical axis) is almost entirely determined by the accuracy of the height set up of the wheels of the LDU. The total range of rail movement in Z-direction is only 2 μm using the same LDU. In the case that the weight or weight distribution of the LDU varies, the stiffness of the suspension should be taken into account.

It was shown that with the steel W-spring suspension the maximum amplitudes of different positions of the optical frame are a factor 2.5 to 6 lower as with the rubber block suspension.

### BRIEF DESCRIPTION OF THE DRAWINGS

FIG. 1 shows and embodiment of the apparatus herein with an LDU on steel W-spring suspension.

FIGS. 2a-k show embodiments of a steel W-spring suspension.

FIG. 3 shows an embodiment of an overall excimer or molecular fluorine laser system.

FIG. 4a/b shows wavelength stability for a system with rubber block suspension.

FIG. 5a/b shows wavelength stability for a system with steel W-spring suspension.

FIG. 6 shows orientation of axis and numbering of feet.

FIG. 7 illustrates a functional view of an embodiment of the invention.

FIGS. 8a-c shows an embodiment of the w-spring suspension.

### DETAILED DESCRIPTION OF THE PREFERRED EMBODIMENTS

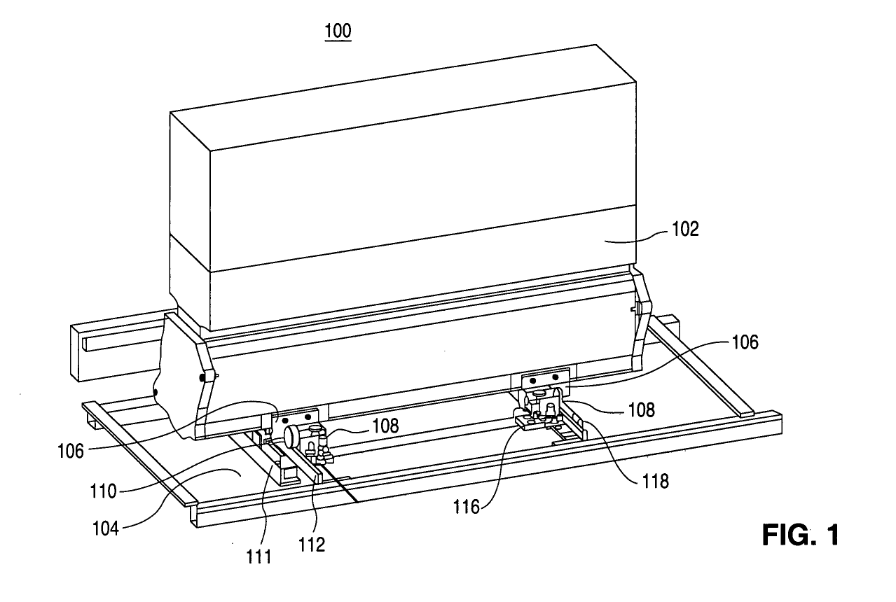

In FIG. 1 aspects of an embodiment of the present system 100 are shown. The system includes an LDU 102. Wheel assemblies 108 are mounted to the LDU 102 by plates 106. The wheel assemblies include wheels 110, and these wheels operate to rotate and position on the LDU on a y-axis support member 112 and a y-axis support member 118. As shown these y axis support members are parallel to a y axis which would be perpendicular to a laser beam output by the LDU which is illustrated in subsequent figures. It should be recognized that aspects of the present invention could be utilized where support members are provided, which are not necessarily oriented on the y axis. Also visible in FIG. 1 is a w-spring 116. As will be made clear in connection with other figures herein, w-springs are coupled to the y-axis support members and to the laser chassis not shown in FIG. 1, so as to dampen vibrations caused by components in the LDU.

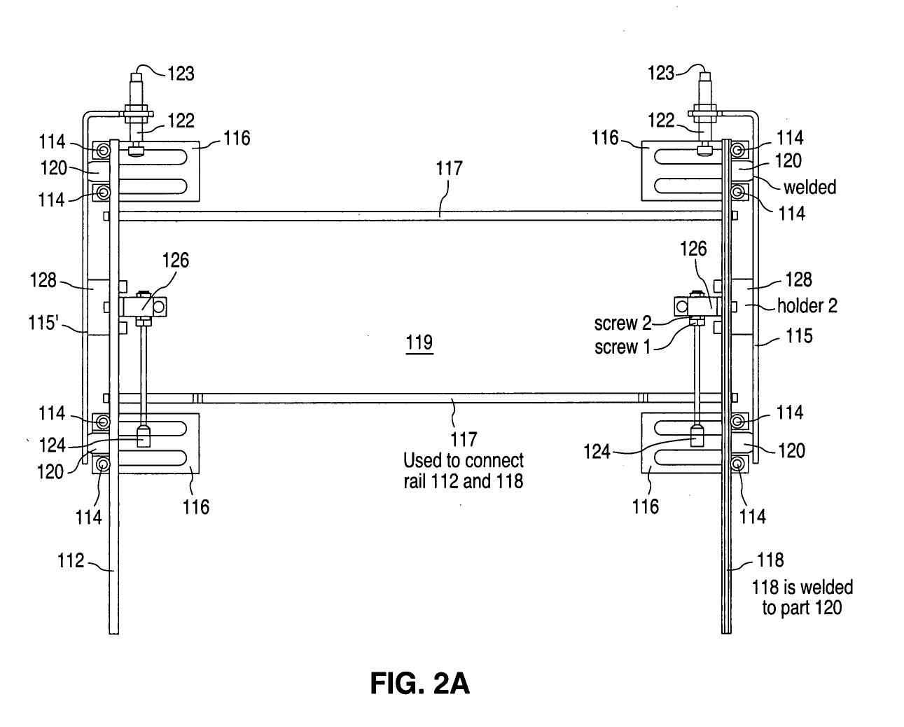

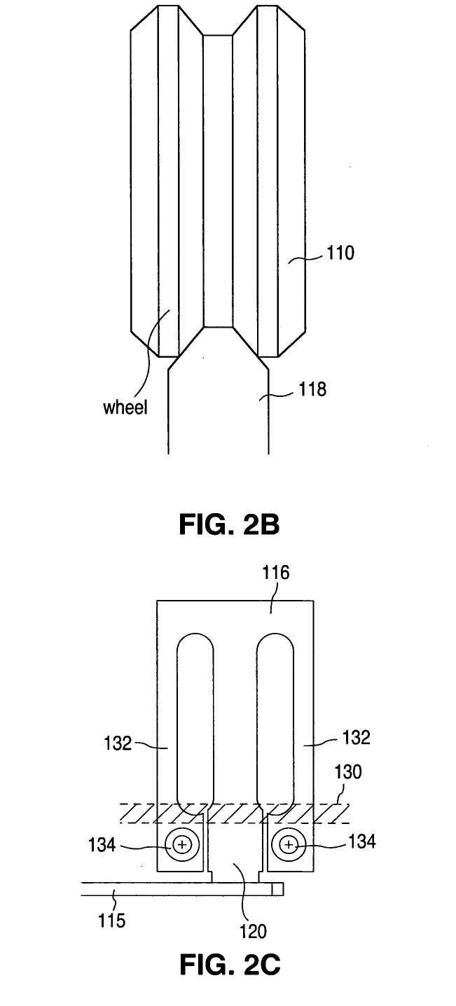

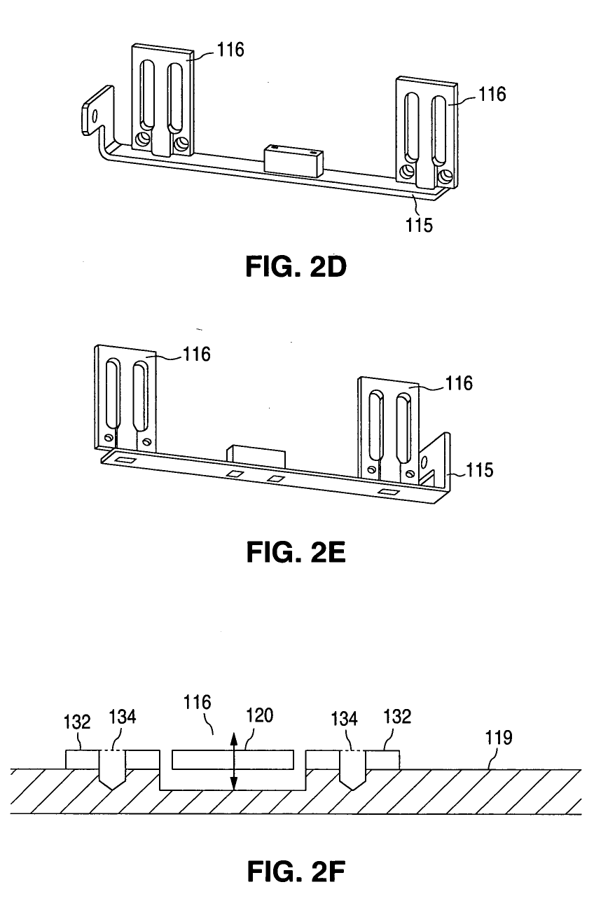

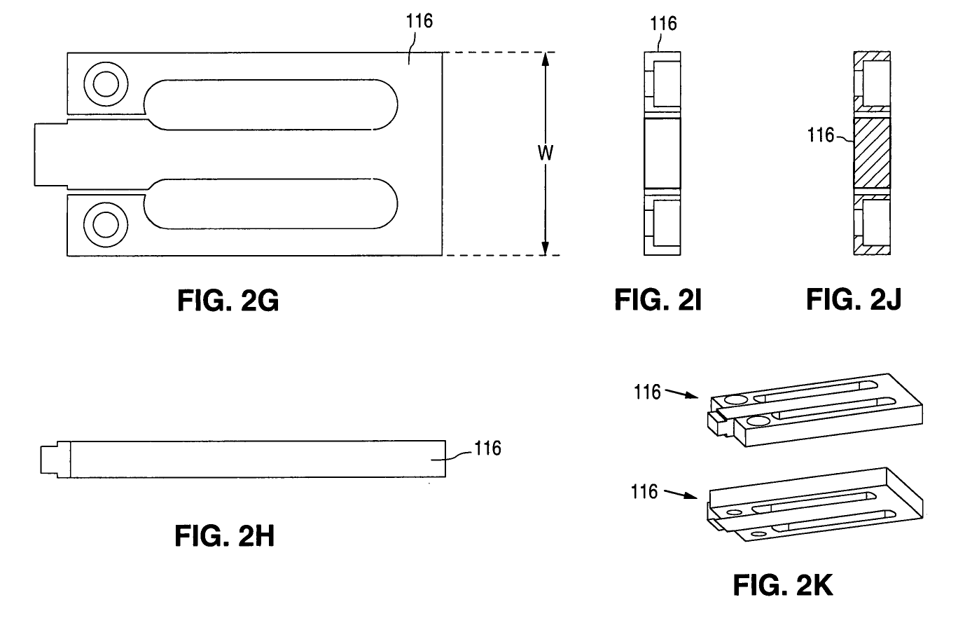

FIGS. 2a-k show more details of the construction of the suspension 104. In some prior rubber block suspension systems pairs of rubber blocks were mounted between the y-axis support members, and the laser chassis underneath the y-axis support members. Generally in these prior systems a pair of rubber blocks where provided at the positions which correspond to the locations of the w-springs 116. As shown in FIG. 2a, a present embodiment herein provides four steel W-springs 116 which are mounted under the y-axis support members 112 and 118 and above a surface of the laser chassis 119. The steel W-springs 116 are welded onto y-axis support member 112 and to y-axis support member 118 which can be a V-rail support member. In one embodiment only the center part 120 of the steel W-springs 116 is welded to the y-axis support members. The members 117 connect the members 112 and 118. The LDU 102 can move on y-axis support member 112 and the V-rail support member 118 and for transport of the whole laser device a special transport safety device is used (not shown) to lock the suspension 104 and the LDU in place relative to each other.

The suspension 104 also includes end stop brackets 115. The end strop brackets 115 are also mounted to center part 120 of the w-springs. This mounting can be done by welding. End stops 122 are coupled to the end stop brackets 115. The end stop faces 123 would come in contact with a side wall of the laser chassis not shown. The end stops are used for positioning the LDU 102 in Y-direction. Differential screw assemblies 124 are used to adjust the LDU 102 in Y-direction. The differential screw assemblies are fixed relative to the y axis support member 112 and 118 by holders 126. Holders 128 operate to couple the y axis support members to the end brackets 115. The differential screw assemblies interface with the wheel assemblies 108, such that as the differential screw is adjusted the position of the wheel assembly moves along the y axis support members.

The position accuracy of the LDU 102 relative to an optics frame is important. The position in Y-direction of the LDU 102 in regard to the optics frame can be determined by adjustable end stops 122 and similar adjustable end stops could also be mounted on the LDU 102. The position in Z-direction is determined by the level or height of the y axis support member 112 and the y axis support member 118, and by the position of the diameter of the wheels 110 of the wheel assemblies 108. The X-direction (axis horizontal along the laser beam), and perpendicular to the y axis is determined by the position of the v-rail 118 and the wheels of the W-spring housings 108 which are positioned above the V-rail 118 (typically these would be v-grooved wheels). For a laser system especially the Y- and Z-directions are of greatest importance.

FIG. 2b shows an enlarged view cut away view of the a v-rail y axis support member 118 and a v grooved wheel 110 above the v-railsl 18. FIGS. 2c-f show views of a w-spring 116 and its mounting to the end stop bracket 115.

FIG. 2c shows a top view of the w-spring 116. The w-spring 116 has a center arm 120 which is welded to the end bracket 115. The w-spring 116 also has outer arms 132, and holes 134 are provided in the outer arms 132. Area 130 corresponds to the area where the y axis support member is adjacent to the w-spring. In one embodiment the y axis member would be welded to the w-spring in the area 130 which overlaps the center arm 120 of the w-spring 116. FIGS. 2d-e show additional view of the w-springs mounted to the end bracket 115.

FIG. 2f is a cross sectional view illustrating the relationship between the w-spring 116 and part of the laser chassis 119. The laser chassis represents the overall housing or structure for a laser system typically the laser chassis would hold or support optics modules, computer controllers and other elements which necessary for the overall operation of a laser system. FIG. 2f show the outer arms of the w-spring 132 having holes 134 in the outer arms. A screw not shown can be used to secure the outer arms 134 of the w spring to the chassis 119. The center portion 120 of the w spring 116 is welded to the end bracket and y support member as discussed above. The vibrational energy of components of the LDU 102 such as the fan, are dissipated by the w spring so as to reduce the vibrations imparted to the laser chassis 119. Thus the w-spring provides a resilient coupling between the laser chassis and the LDU which dissipates vibrational energy in the system.

FIG. 2g shows a mechanical drawing of a top view of the w-spring 116. FIG. 2h shows a lateral side view of the w-spring 116, and FIGS. 21 and 2j show end views of the w spring 116. FIG. 2k shows isometric view of the w-spring 116. The dimension w shown in FIG. 2g in one embodiment is approximately in the range of 66 mm, and FIGS. 2h-2j are all shown in the same scale. FIG. 2k is shown in half scale relative to the FIGS. 2g-2j. One suitable type of material for the w-spring is a stainless steel alloy, by the trade name Nitronic 60, and available from High Performance Alloys, Inc. Tipton, Ind. 46072. This steel alloy includes silicon and manganese which helps to improve the performance of the metal. It should be recognized that other materials could also provide suitable performance for the w-spring. Further, although the figures herein show w-springs, where this springs are roughly shaped in manner which corresponds to the w-shape, in that the springs have to outer arms and a center arm, it should be recognized that other metal spring shapes could be used. For example other relatively planar shaped springs could be used to provide a resilient connection between the laser chassis and the LDU which dampens vibrations caused by elements of the system.

FIG. 7 shows a functional view of aspects of the overall laser system 100. The laser system includes the laser chassis 19 to which other components of the system are mounted. The other components include a front optics frame 706 and a rear optics frame 708.

Mounted to the front optics frame 706 is a front optics module 710, and mounted to the rear optics frame 708 is a rear optics module 712. The LDU 102 needs to be correctly aligned with the optics modules 710 and 712 in order to put out light energy on the correct optical axis 714. The columns 702 and 704 represent the w-springs which couple the LDU 102 to the laser chassis 119. The w-springs operated to dissipate vibrations caused by the operation of elements such as the fan of the LDU 102, and this in turn provides for the LDU being in better alignment with the desired optical axis 714.

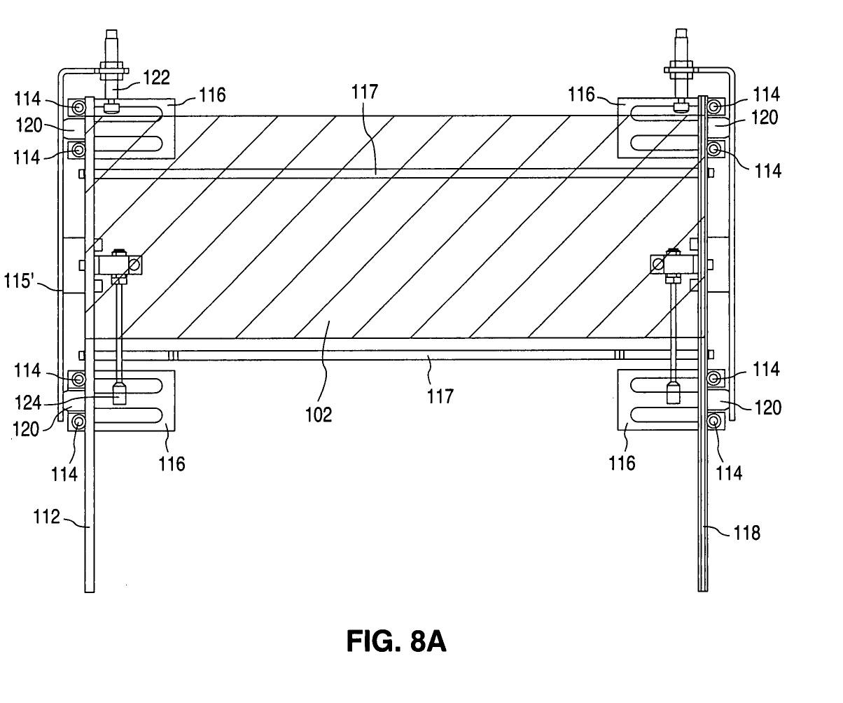

FIG. 8a shows a top view of the suspension system similar to that shown in FIG. 2a, but in addition the hatched area shows a positioning of the LDU 102 relative to other components of the system. FIGS. 8b-c show two high level view of a laser system. In FIG. 8b the LDU 102 is correctly aligned with the front optics module 710 and the rear optics module 712 and the desired optical axis 714. In FIG. 8c the LDU 102 is not correctly aligned with the optics modules 710 and 712, or the optical axis 714. The differential screw assemblies 124 discussed above in connection with FIG. 2a could be used to the adjust the alignment of the LDU 102 to bring it in proper alignment.

On a test system an optical axis of the LDU was adjusted to a selected position. For this the wheels 110 and end stops 122 have to be adjusted, and the LDU suspension 104 was adjusted to a selected level of the optics frame and end of the adjustable stops 122 are set to the selected position. After this procedure it should be possible to exchange LDUs with different suspension systems without extra fine tuning of the LDU position to the optics frame. This is possible when the position error is within the allowable tolerances. The position error is determined by the set up accuracy, position stability and the position repeatability after remounting.

An embodiment of the present invention provides significantly improved position stability over time relative to prior rubber suspension systems. The long time position stability of an embodiment of a w-spring suspension 104 has been measured. These measurements show that the small position divergences in different situations correlate more with temperature than with time, so the position stability error for the new steel W-spring suspension can be neglected.

To determine the set up accuracy of the LDU 102 position relative to the optics frame the accuracy of the fine adjustment of the adjustable stops 122, and adjustable stops on the LDU in Y-direction was measured (these stops on the LDU are not shown in the figures). The LDU position is determined by the position of these adjustable end stops. The end stops are adjustable by a differential screw. The pitch difference of the differential screw in this end stop is 0.25 mm. The feasible adjustment resolution with this system is about 1/60 of a revolution. This means a 4 μm range per end stop (±2 μm). To fix the loose differential screw a fixation screw is tightened after the position is set. This can influence the previous set position with maximum +10 μm (20 μm range). The set position accuracy of 10 μm after the fixation screw is tightened can be at least 5 μm higher, if the position is measured afterwards and the set position is altered accordingly. This means the positional error of the LDU optical axis in Y-direction to the optical frame can be 14 μm. This means the set accuracy of the optical axis regardless of the LDU will be within a range of 28 μm in Y-direction of the optical frame.

To achieve a high repeatability the suspension has to be free of hysteresis and all the degrees of freedom of the LDU have to be statically determined. In the new design this was reached by using a suspension of steel W-springs that has very little internal friction and a fixation in the Y-axis that does not influence other degrees of freedom.

Some measurements were made as discussed below to determine what effect the w-spring suspension herein had in terms of enhancing the repeatability of positioning the LDU, when the LDU is remounted. In the context of this discussion regarding these measurements, remounting was implemented by moving the LDU to the end of the y-axis rails and riding it back again and then tightening the locking screws. The forces on the suspension were representative for the forces that occur when the LDU is transferred a service lorry outside the laser frame. To fix the LDU the screws have to be tightened with 2 Nm for rubber block suspension and between 3 and 10 Nm for the steel W-spring suspension. For the rubber block suspension the tightening couple is of influence for the position. For the steel W-spring suspension it is not.

To make the measurements shown below 5 different gauges were mounted to the on the optics frame. To read out the gauges a gauge block was held between the dial gauge and the LDU. This is to avoid the possibility that the dial gauges are disturbed when the LDU is moved back and forth over the suspension rail. The measurement results for the rubber block suspension were obtained after the LDU was mounted the day earlier. Measurements immediately after mounting the LDU on fresh rubber blocks gave inaccurate results, because it seamed the rubber was still settling.

Resolution of the gauges 1, 2, 3 and 4 was 2 μm. The resolution of gauge 5 was 10 μm. Gauges 1 and 3 measure the Z-direction of both ends of the LDU. The gauges 1 and 3 were positioned 60 mm behind the optical axis. Gauge 5 measured the Y-direction 220 mm above the optical axis. Gauges 2 and 4 measured the Y-direction 50 mm above the optical axis.

The maximum measured position repeatability range measured in a 15 minutes period at the laser beam output level for a prior rubber block suspension was 30 μm in Y-direction and 6 μm in Z-direction.

The maximum measured position repeatability range at the laser beam output level for the new steel W-spring suspension was 12 μm in Y-direction and 2 μm in Z-direction.

These results show that the position repeatability over a short period is increased using the steel W-spring suspension.

The above mentioned measurements were done without water filling of the heat exchanger. To measure the positional influence of the water in the heat exchanger a 10 kg load was put on the top of the LDU. The measurements show clearly that the LDU is not able to move freely in Z-direction when using the original rubber block suspension. The reason for this is that the fixation of the LDU in Y-direction also fixates the front end of the LDU in Z-direction. Only the back end of the LDU can lower in the rubbers when a load is applied. In this case the LDU rotates around the fixation on the front and the optical axis will move in Y-direction backwards. Due to the present construction there is more displacement in Y-direction than in Z-direction.

The results for the new steel W-spring suspension with a 10 kg load on the LDU show that a sudden change in load or an external force on the LDU causes a motion of the LDU. This motion is extinguished within 30 seconds by the steel W-spring suspension. Under normal operation of the laser the LDU position will remain stable.

The most important function of the LDU suspension is to prevent the transmission of vibrations of the fan in the LDU to the optics frame. To be able to compare this isolation function of the suspension, vibrations of the optics frame have been measured for both types of suspension during operation of the fan at 57 Hz.

To measure the amplitudes of the vibrations Bruel & Kjaer Charge accelerometer type 4384 V were attached to a surface of the optics frame. The accelerometer measures the acceleration perpendicular to the surface during a period.

To eliminate the low frequency noise of the accelerometer the signal is cut off below 15 Hz. By integrating the filtered measuring result two times the amplitude is calculated. Six different positions of the surface of the optics frame have been chosen for the measurements.

The measurement results show that with the new steel W-spring suspension the vibrations are much better isolated than with the rubber block suspension. The reason for this result is that rubber block suspension is not able to move freely on the front side of the LDU. On this side it is fixed hard to the laser chassis and so the vibrations of the fan are transmitted directly into the laser chassis.

As discussed in the Background section vibrations caused by the fan have a strong influence on the wavelength, bandwidth and energy stability of the laser device.

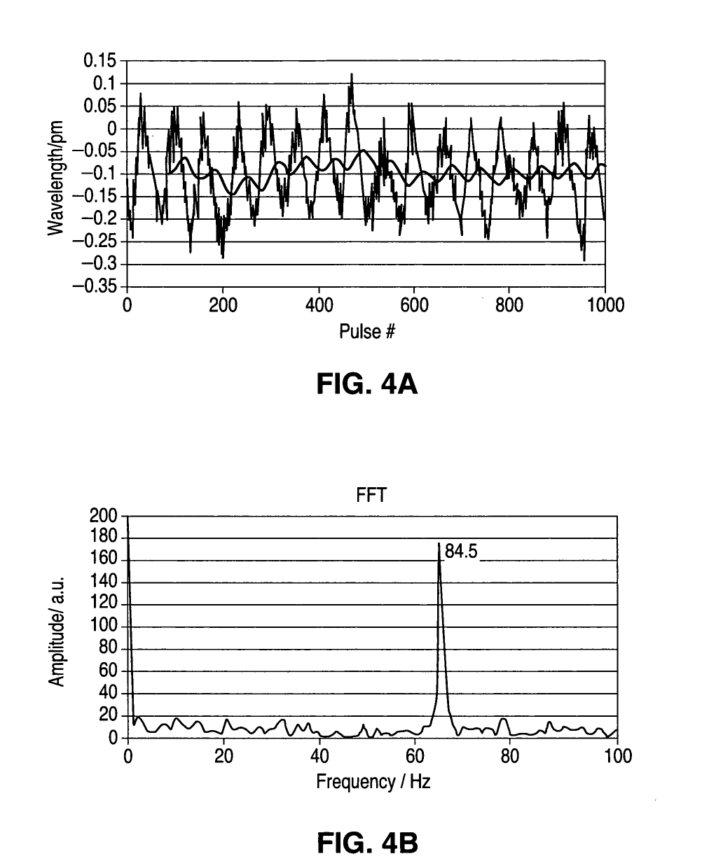

In FIG. 4a it can be clearly seen that the vibrations of the fan give a characteristic pattern to the wavelength stability. Specifically, FIG. 4a shows the wavelength stability for an LDU which is mounted to a rubber tube suspension type of system, where the laser is operated at 4 kHz without stabilization. FIG. 4b shows the vibration of the suspension system which is caused by the operation of the fan. As shown the suspension system experiences significant vibration at 64.5 Hz the operation frequency of the fan.

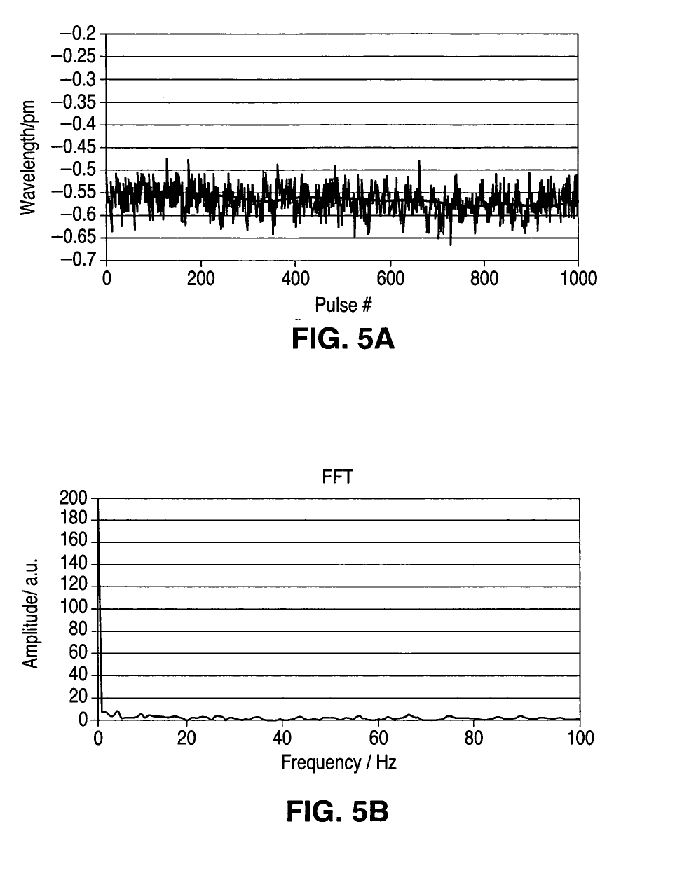

FIG. 5a shows the wavelength stability for an LDU which is mounted to a w-spring type suspension as described above, and where the laser is operated at 4 kHz without stabilization. FIG. 5b shows the vibration of the suspension system which is caused by the operation of the fan. As shown the suspension system experiences significantly less vibration than the system shown in FIGS. 4a and 4b.

The frequency of the fan is in this case 64.5 Hz like it is shown in FIG. 4b. Also the influence of the fan vibrational operation on the bandwidth and energy stability is reduced with the new suspension.

As explained above rotating parts such like the fan and his motor cause vibrations. The amplitude of these vibrations can be a measure for the condition of the rotating parts. Vibrational amplitudes increase as the balancing of the rotating parts or the bearings of the fan becomes worse. The increase should regularly be continuous and already noticeable prior failure of the parts. Steady or intermittent analysis of vibrations by acceleration sensors (mechanical, electrical, capacitive, piezo-electrical) will allow a pre-failure diagnosis, which is necessary for scheduling of repairs. The measured level of vibrations may also be useful to limit the maximum speed of older parts until a repair will be possible or unavoidable. The measurement of vibrations with the sensors is also helpful to adjust the rotating speed of the parts outside resonance frequencies to reduce their wear and to reduce vibrations of sensitive parts of the laser. Especially, the adjustment of resonator optics is very sensitive to vibrations. Sensor-assisted control of rotating parts helps to reduce vibrational amplitudes in general and can shift rotational frequencies to ranges outside the resonances of the sensitive parts and their supporting structures. Acceleration sensors in the excimer laser can also detect “non-allowed” vibrations of the floor. This will allow to identify external reasons for a bad performance of the laser. Finally, the acceleration sensors can enable an active damping of vibrations by accordingly controlled piezo-electric actuators. The sensors measure the frequency, amplitude and phase of vibrations and the actuators are controlled using this information in such a way that the amplitudes are damped. This active damping may be applied to the source of vibration or to the most sensitive parts only. Flowing media such as cooling liquids, air or other gases also cause vibrations inside a excimer laser. Measurement of these vibrations can be useful to control the flows in such a way that turbulences and the resulting strong vibrations can be avoided. Unusual vibrations caused by flowing media can also be an indicator for defects in the flow systems. The development and design of excimer lasers can be clearly improved and accelerated by using acceleration sensors for measuring the above mentioned vibrations of rotating parts, structures, sensitive components and flowing media. A detailed analysis of such measuring results will allow directed modifications of the critical components. The optimum position of the acceleration sensors depends on their special purpose. Sensors can be located close to the sources and transmitters of vibrations as well as at the sensitive parts. This will allow either to analyze the sources or to detect and control vibrations at the sensitive components.

A further invention is the sensor-assisted horizontal leveling and height adjustment of excimer lasers. Excimer lasers and many other heavy devices are usually supported by 4 or more feet to guaranty a sufficient stability towards tilt. Some heavy devices such as excimer lasers require exact leveling (and height adjustment) during installation, after transport and/or during operation. Usually leveling is done by adjusting manually the height of the individual feet (e.g. by screwing) and measuring the inclination with spirit-levels.

Manual adjustment and measurements with spirit-levels are time-consuming. The precision of spirit-levels is limited and a considerable offset requires averaging of measurements with opposite orientation of the level. Horizontal leveling exhibits 2 degrees of freedom only (inclination of the x and y axis). Therefore, torsion-free leveling by height adjustment of feet is only guarantied with 3 feet (one height may be fixed and the other two may be adjusted to level the two axes). However, three feet do not give sufficient stability for heavy devices, and the adjustment of both axis is coupled. Coupled adjustment of the two axis is time-consuming and exhibits limited precision since repeated re-adjustment of the first foot is necessary after adjusting the second one. Individual height adjustment of 4 or more feet may lead to considerable torsion within the frame or base plate of the device. This torsion may affect the positioning and adjustment of components mounted on the frame or base plate. The weight of the device may be unevenly distributed on the feet after such an adjustment. This may result in too high pressure or force at some feet.

The mentioned drawbacks can be avoided by sensor-assisted leveling. The principles are described below for 4 feet, and similar procedures can be easily worked out for larger numbers of feet. In any case, one foot can be fixed, two are used for leveling of the two horizontal axes and the other feet are adjusted for proper weight distribution to avoid torsion.

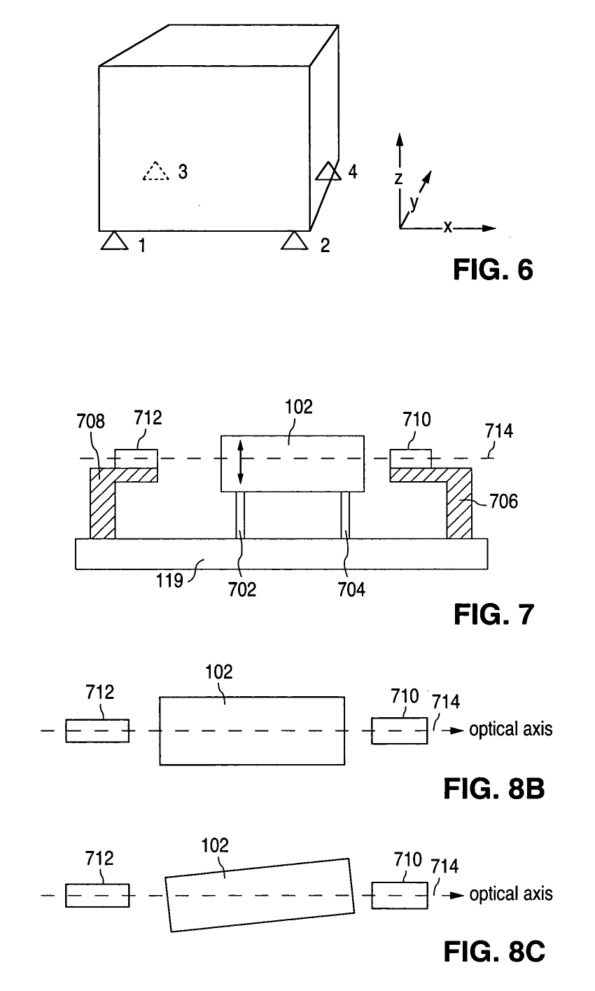

Basically, as described in connection with FIG. 6, torsion-free and separate leveling of the two horizontal axes (x and y) of a device can be achieved in the following way: One foot (1) is fixed, the neighbored feet (2 and 3) are used for leveling of either x- or y-axis and the opposite foot (4) is used for balancing the forces only (scheme 1). When foot 4 is permanently adjusted in such a way that it carries the proper weight (e.g. one quarter of the total weight for a device with evenly distributed weight), there will be no induced torsion at all, and foot 2 and 3 can be used for individual leveling of the x and y axes, respectively, without affecting the leveling of the other axis. The key idea of the proposed leveling procedure is to use the foot opposite to the fixed one for balancing the weight force distribution among the feet only. This requires the detection of the force, a related pressure or tension.

Different types of sensors (optical, piezo-electrical, electrical and others) can be used for a convenient steady detection of the force on or under the foot, the pressure above, inside or under the foot or the tension inside the foot. Sensors may be installed permanently at devices that need regular leveling or they may be installed for the leveling procedure only. If necessary, calibration of sensors may be done easily by determining the maximum load on the foot (4) by loosening foot 2 or 3 until one of them is disconnected from the ground.

With a force/pressure or tension sensor, the same weight distribution and torsion can be obtained for repeated leveling. Therefore, factory or other settings for the adjustment of internal components will hold for installation at different locations. Extensive readjustments may become obsolete.

Inclination sensors may be used for automatic leveling of x and y axes. These sensors can produce electrical signals that are suited to control the height adjustment of the feet. Furthermore, these sensors are much more precise and exhibit better repeatability than conventional spirit-levels. Much higher accuracy of leveling can be achieved in a clearly shorter time. Automatic control makes leveling independent of individual skills of people involved in the adjustment.

Very similar procedures as described above for leveling can be used for height adjustment. The foot 1, which is fixed during leveling, may be used for adjusting the height, foot 2 and 3 are adjusted for proper leveling and the other foot/feet are adjusted for proper weight distribution.

The proposed adjustment schemes are quite simple, and each foot can be controlled separately from a single parameter (height, inclination of x or y axis, weight/pressure). This allows separate automatic control of one, some or all feet. Foot 1 may be controlled according to the nominal height or the signal from a height sensor. Feet 2 and 3 may be controlled according to the measured inclination of x and y axis, respectively. Further feet may be controlled according to the individual weight/pressure on them. Especially, automatic control of weight distribution would make leveling very easy. Manual adjustment of feet 2 or 3 would exclusively level x or y axis, respectively. Automatic adjustment of further feet serves for optimum weight distribution and minimum torsion at any time and thus makes repeated readjustments obsolete.

### General Description of Overall Laser System

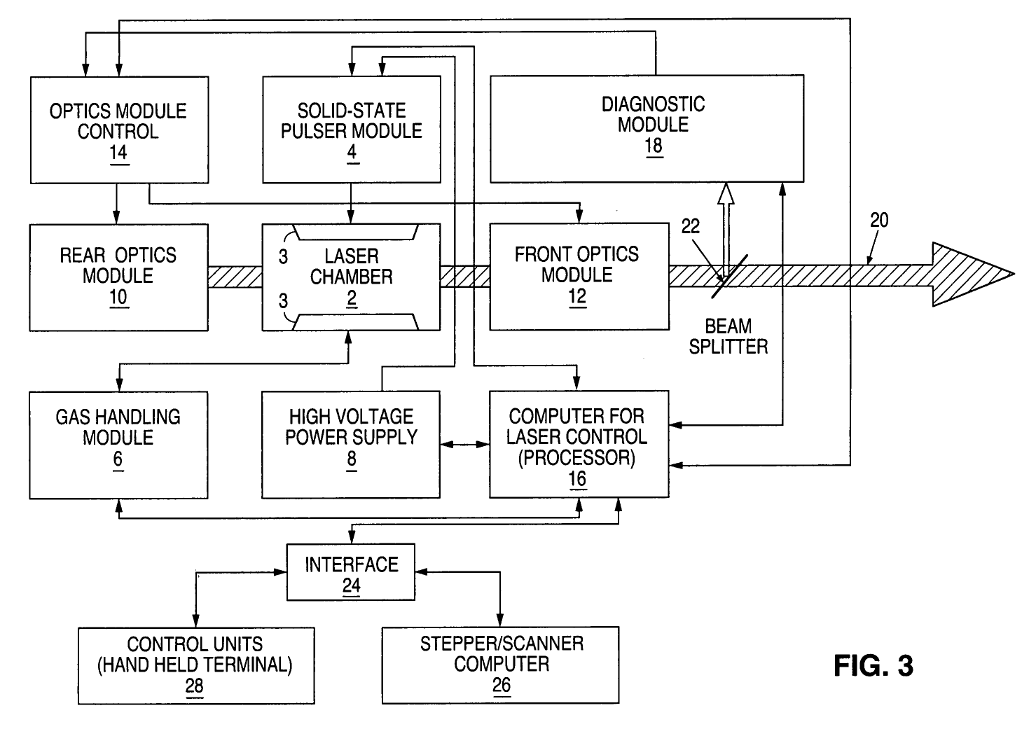

FIG. 3 schematically illustrates an overall excimer or molecular fluorine laser system according to a preferred embodiment. Referring to FIG. 3, an excimer or molecular fluorine laser system is schematically shown according to a preferred embodiment. The preferred gas discharge laser system may be a VUV laser system, such as a molecular fluorine (F₂) laser system, for use with a vacuum ultraviolet (VUV) lithography system, or may be a DUV laser system such as a KrF or ArF laser system. Alternative configurations for laser systems for use in such other industrial applications as TFT annealing, photoablation and/or micromachining, e.g., include configurations understood by those skilled in the art as being similar to and/or modified from the system shown in FIG. 3 to meet the requirements of that application. For this purpose, alternative DUV or VUV laser system and component configurations are described at U.S. patent application Ser. Nos. 09/317,695, 09/130,277, 09/244,554, 09/452,353, 09/512,417, 09/599,130, 09/694,246, 09/712,877, 09/574,921, 09/738,849, 09/718,809, 09/629,256, 09/712,367, 09/771,366, 09/715,803, 09/738,849, 60/202,564, 60/204,095, 09/741,465, 09/574,921, 09/734,459, 09/741,465, 09/686,483, 09/715,803, and 09/780,124, and U.S. Pat. Nos. 6,005,880, 6,061,382, 6,020,723, 5,946,337, 6,014,206, 6,157,662, 6,154,470, 6,160,831, 6,160,832, 5,559,816, 4,611,270, 5,761,236, 6,212,214, 6,154,470, 6,269,110, 6,219,368, 6,298,080, 6,243,405, 6,243,406, and 6,198,761, each of which is assigned to the same assignee as the present application and is hereby incorporated by reference.

The system shown in FIG. 3 generally includes a laser chamber 2 (or laser tube including a heat exchanger and fan for circulating a gas mixture within the chamber 2 or tube) having a pair of main discharge electrodes 3 connected with a solid-state pulser module 4, and a gas handling module 6. The gas handling module 6 has a valve connection to the laser chamber 2 so that halogen, rare and buffer gases, and preferably a gas additive, may be injected or filled into the laser chamber, preferably in premixed forms (see U.S. patent application Ser. No. 09/513,025, which is assigned to the same assignee as the present application, and U.S. Pat. No. 4,977,573, which are each hereby incorporated by reference) for ArF, XeCl and KrF excimer lasers, and halogen and buffer gases, and any gas additive, for the F₂ laser. For the high power XeCl laser, the gas handling module 6 may or may not be present in the overall system. The solid-state pulser module 4, including preferably an IGBT switch, and alternatively a thyristor or other solid state switch, is powered by a high voltage power supply 8. A thyratron pulser module may alternatively be used. The laser chamber 2 is surrounded by optics module 10 and optics module 12, forming a resonator. The optics module may include only a highly reflective resonator reflector in the rear optics module 10 and a partially reflecting output coupling mirror in the front optics module 12, such as is preferred for the high power XeCl laser. The optics modules 410 and 412 may be controlled by an optics control module 14, or may be alternatively directly controlled by a computer or processor 16, particular when line-narrowing optics are included in one or both of the optics modules 10, 12, such as is preferred when KrF, ArF or F₂ lasers are used for optical lithography.

The processor 16 for laser control receives various inputs and controls various operating parameters of the system. A diagnostic module 18 receives and measures one or more parameters, such as pulse energy, average energy and/or power, and preferably wavelength, of a split off portion of the main beam 20 via optics for deflecting a small portion of the beam toward the module 18, such as preferably a beam splitter module 22.

The beam 20 is preferably the laser output to an imaging system (not shown) and ultimately to a workpiece (also not shown) such as particularly for lithographic applications, and may be output directly to an application process. The laser control computer 16 may communicate through an interface 24 with a stepper/scanner computer, other control units 26, 28 and/or other external systems.

Although specific embodiments and methods of the present invention are shown and described herein, this invention is not to be limited by these methods and embodiments. Rather, the scope of the invention is to be defined by the following claims and their equivalents.

What is claimed is:

1. A suspension system for mounting a laser discharge unit to a laser chassis, including:
a first support member;
a second support member;
wherein the first support member and the second support member support the laser discharge unit;
a first metal spring and a second metal-spring coupled to the first support member, and the first and second metal spring coupled the laser chassis such the first support member is resiliently coupled to the laser chassis; and
a third metal spring and a fourth metal spring coupled to the second support member, and third and fourth metal spring coupled to the laser chassis such that the second support member is resiliently coupled to the laser chassis.

2. The suspension system of claim 1, the first metal spring is a planar spring having multiple arms, wherein a first arm of the planar spring is fixed to the first y member, and a second arm of the planar spring is fixed to the laser chassis.

3. The suspension system of claim 1, the first metal spring, the second metal spring, the third metal spring and the fourth metal springs are planar springs having multiple arms, and wherein a first arm of the first metal spring is fixed to the first support member, and a second arm of the planar spring is fixed to the laser chassis, and wherein a first plane is defined by a surface of the laser chassis to which the second arm is fixed, and a second plane is defined by a surface of the first support member to which the first arm of the first metal spring is attached, and a third plane is defined by the first metal spring, and the first plane, the second plane and the third plane are parallel.

4. The suspension system of claim 1, wherein each of the first through the fourth metal springs are planar springs having a two outer arms and one center arm, and the two outer arms are fixed to the laser chassis, and the center arm is fixed to one of support members, and the two outer arms and the center arm define a single plane.

5. The suspension system of claim 1, wherein each of the first through the fourth metal springs are planar springs each having at least a first arm and a second arm, and a and the first arms of the first and second metal springs are coupled to the first support member, and the second arms of the first and second metal springs are coupled to the laser chassis, and wherein the first arms of the third and fourth metal springs are coupled to the second support member, and the second arms of the third and fourth metal springs are coupled to the laser chassis, and wherein arms of the metal springs define a single plane.

6. The suspension system of claim 5 further including:
a first pair of wheel assemblies mounted to the laser discharge unit, and wherein a wheel of each of the first pair of wheel assemblies is positioned on top of the first support member; and
a second pair of wheel assemblies mounted to the laser discharge unit, and wherein a wheel of each of the second pair of wheel assemblies is positioned on top of the second support member.

7. The suspension system of claim 1, wherein the second support member is a v-rail member.

8. The suspension system of claim 1, wherein the metal springs operate reduce the influence of vibration on a bandwidth of a laser beam generated by the laser discharge unit.

9. The suspension system of claim 1, wherein the metal springs reduce the influence of vibration on a wavelength of a laser beam generated by the laser discharge unit.

10. The suspension system of claim 1, wherein the metal springs reduce the influence of vibration on an energy stability of a laser beam generated by the laser discharge unit.

11. A laser system including:
a laser discharge unit;
a laser chassis;
an optics frame coupled to the laser chassis;
a first y axis support member;
a second y axis support member;
wherein the first y axis support member and the second y axis support member support the laser discharge unit;
a first planar metal spring and a second planar metal-spring coupled to the first y axis support member, and the first and second metal spring coupled the laser chassis such the first y axis support member is resiliently coupled to the laser chassis; and
a third planar metal spring and a fourth planar metal spring coupled to the second y axis support member, and third and fourth metal spring coupled to the laser chassis such that the second y axis support member is resiliently coupled to the laser chassis.

12. The suspension system of claim 11, further including at least two accelerometers mounted to the optics frame for monitoring of vibrations.

13. The suspension system of claim 11, further including an inclination sensor to level a gas discharge laser or molecular fluorine laser.

14. The suspension system of claim 13, wherein the inclination sensor is an optical sensor.

15. The suspension system of claim 13, wherein the inclination sensor is a piezo-electrical sensor.

16. The suspension system of claim 13, wherein the inclination sensor is an electrical sensor.
